(19) United States
(12) Patent Application Publication
(10) Pub. No.: US 2017/0250595 A1
(43) Pub. Date: Aug. 31, 2017

(54) BRUSHLESS DIRECT CURRENT MOTOR

(71) Applicant: CONTINENTAL AUTOMOTIVE GMBH, Hannover (DE)

(72) Inventors: Hans-Dieter Wilhelm, Darmstadt (DE); Eugen Bernarding, Usingen (DE); Wolfram Triller, Wiesbaden (DE); Thomas Mann, Nidderau (DE); Helmut Westenberger, Hofheim (DE); Peter Kohlen, Neu Anspach (DE)

(73) Assignee: CONTINENTAL AUTOMOTIVE GMBH, Hannover (DE)

(21) Appl. No.: 15/592,720

(22) Filed: May 11, 2017

Related U.S. Application Data
(63) Continuation of application No. PCT/EP2015/076452, filed on Nov. 12, 2015.

(30) Foreign Application Priority Data
Nov. 14, 2014 (DE) 10 2014 223 276.7
Mar. 19, 2015 (DE) 10 2015 205 010.6

(51) Int. Cl. H02K 21/14; H02K 1/28; H02K 1/27

(52) U.S. Cl. CPC H02K 21/14; H02K 1/278; H02K 1/28

(57) ABSTRACT

A brushless direct current motor with a stator and rotor uses permanent magnets facing the stator and which are held in place by springs that urge the magnets toward the periphery of a support structure for the rotor.

### BACKGROUND

Brushless direct current motors are utilized in motor vehicles for different drives and are known from practical application. According to the prior art, the permanent magnets of the rotor are encapsulated in plastic. It is also known from practical application to fasten the permanent magnets on the support element using a sleeve.

The disadvantage of the known direct current motors, however, is that an encapsulation or a sleeve results in an increase in the spacing of the permanent magnets from the coils. A large spacing results in high magnetic leakage, however, and, therefore, to low efficiency of the direct current motor. Sliding a sleeve over the permanent magnets also results in a very large amount of effort to assemble the direct current motor.

### SUMMARY

The problem addressed by the invention is that of refining a direct current motor of the type mentioned at the outset in such a way that said motor allows for a reliable attachment of the permanent magnets and allows for particularly small spacings between the permanent magnets of the rotor and the coils of the stator.

This problem is solved according to the invention by way of the permanent magnets directly delimiting an air gap with respect to the rotor and being preloaded against the periphery of the support element.

Due to this configuration, the permanent magnets can be situated directly in front of the coils of the stator. The particularly narrow size of the air gap is therefore limited almost exclusively by a thermal expansion and by production tolerances of the adjacent components of the stator and the rotor. Due to this configuration, the direct current motor according to the invention has high efficiency. Thanks to the invention, components for holding the permanent magnets no longer need to be situated in front of the permanent magnets. The preload can be selected in such a way that centrifugal force is counteracted. Therefore, the preload ensures a reliable attachment of the permanent magnets even at high rotational speeds. The brushless direct current motor according to the invention is therefore suitable, in particular, for driving an electrically operated compressor of an internal combustion engine of the motor vehicle. In addition, thanks to the invention, the rotor can be installed in a particularly economical manner.

According to yet another advantageous refinement of the invention, the preloading of the permanent magnets is implemented using a particularly simple design when spring elements connected to the support element grip an edge of the permanent magnets that is situated in parallel to the rotational axis of the rotor and has a widened portion.

According to yet another advantageous refinement of the invention, an air gap between the permanent magnets of the rotor and the coils of the stator can be kept particularly low when the permanent magnets have recesses for accommodating a subregion of the spring elements, which recesses are situated on each of the edges of said magnets that are situated in parallel to the rotational axis.

According to yet another advantageous refinement of the invention, the spring elements can be connected particularly easily to the support element when the spring elements grip an edge of the support element that is situated in parallel to the rotational axis of the rotor.

According to yet another advantageous refinement of the invention, the rotor is provided with a particularly simple design when the support element comprises several channels which are situated in parallel to the rotational axis of the rotor for accommodating one end of the spring elements.

According to yet another advantageous refinement of the invention, the spring elements can be produced particularly economically when the spring elements are designed to have a C-shaped cross section.

According to yet another advantageous refinement, the spring elements are reliably held in their position when two spring elements are supported against one another in order to hold permanent magnets which are adjacent to one another. Due to this configuration, the spring elements on the permanent magnet, the support element, and the adjacent spring element are supported at three points overall. The rotor therefore has high stability. This also results in a particularly small installation space for holding the permanent magnets.

According to yet another advantageous refinement of the invention, the number of components of the brushless direct current motor can be kept particularly low when the number of spring elements is identical to the number of permanent magnets and when each of the spring elements is situated between two permanent magnets which are adjacent to one another.

According to yet another advantageous refinement of the invention, the brushless direct current motor is particularly suitable for high rotational speeds when each of the spring elements is held in a middle section thereof in the channel in the support element and supports, by way of the outer sections, permanent magnets which are adjacent to one another in each case. Due to this configuration, the preload on the permanent magnets is particularly uniform around the periphery of the support element. This prevents strong loads on the edges of the permanent magnets.

According to yet another advantageous refinement of the invention, the production of the permanent magnets and of the support element is particularly economical when the permanent magnets and the support element have planar contact surfaces.

According to yet another advantageous refinement of the invention, an additional positional fixation of the spring elements and, therefore, of the permanent magnets can be easily achieved when the spring elements and a subregion of the support element that holds the spring elements are encapsulated in plastic.

The invention provides for numerous embodiments. In order to further illustrate the basic principle of the invention, two embodiments are represented in the drawing and are described in the following.

### BRIEF DESCRIPTION OF THE FIGURES

FIG. 1 schematically shows a cross section through a brushless direct current motor;

FIG. 2 shows, in greatly enlarged fashion, a subregion of a rotor of the direct current motor from FIG. 1;

FIG. 3 shows one further embodiment of the rotor; and

FIG. 4 shows a cross section through one further embodiment of the rotor.

### DETAILED DESCRIPTION

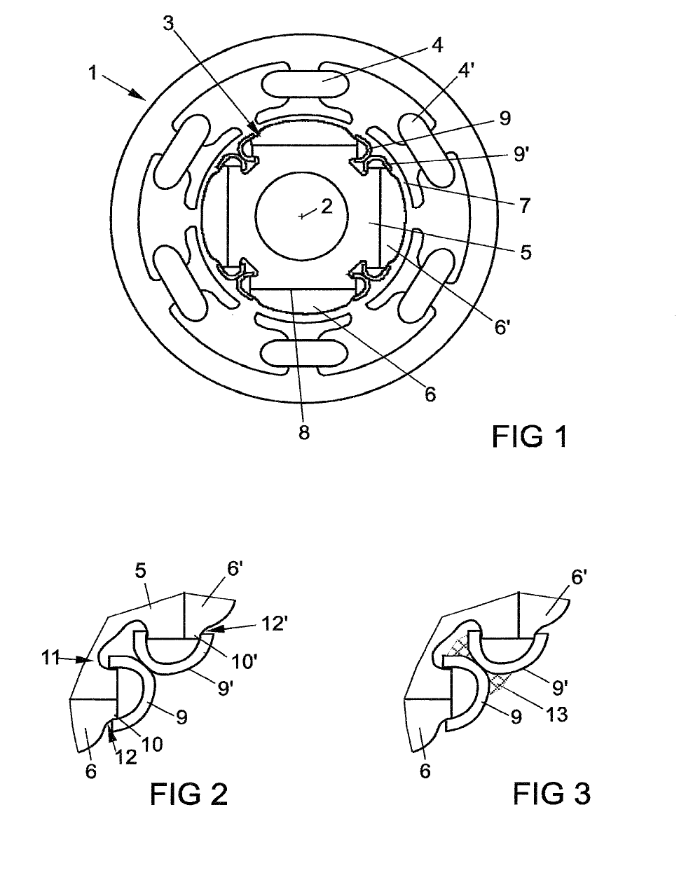

FIG. 1 schematically shows a cross section through a brushless direct current motor comprising a fixed stator 1 and a rotor 3 which is mounted so as to be rotatable about a rotational axis 2 situated perpendicularly to the plane of the drawing. The stator 1 comprises several coils 4, 4′. The rotor 3 comprises several permanent magnets 6, 6′ which are situated on a support element 5. The support element 5 is designed as a laminated core. An air gap 7 is situated between the permanent magnets 6, 6′ and the coils 4, 4′. The permanent magnets 6, 6′ therefore directly delimit the air gap 7. The permanent magnets 6, 6′ and the support element 5 have planar contact surfaces 8. The rotor 3 comprises spring elements 9, 9′ for preloading the permanent magnets 6, 6′ against the support element 5.

FIG. 2 shows, in greatly enlarged fashion, an abutting region of two permanent magnets 6, 6′ and of the support element 5 of the rotor 3. The spring elements 9, 9′ are each C-shaped and grip an edge 10, 10′, respectively, of the permanent magnets 6, 6′. The support element 5 comprises a channel 11, into which the spring elements 9, 9′ grip. The channel 11 and the edges 10, 10′ of the permanent magnets 6, 6′ are situated perpendicularly to the plane of the drawing and, therefore, in parallel to the rotational axis 2 of the rotor 3. The edges 10, 10′ have a recess 12, 12′, respectively, for accommodating a subregion of the spring elements 9, 9′. FIG. 2 also shows that spring elements 9, 9′, which are adjacent to one another, are supported against one another.

FIG. 3 shows one further embodiment of the rotor 3 in the abutting region of two permanent magnets 6, 6′, which differs from the embodiment according to FIG. 2 only in that the spring elements 9, 9′ have an encapsulation 13 made of plastic in the abutting region. The encapsulation 13 fixes the spring elements 9, 9′ in their position shown.

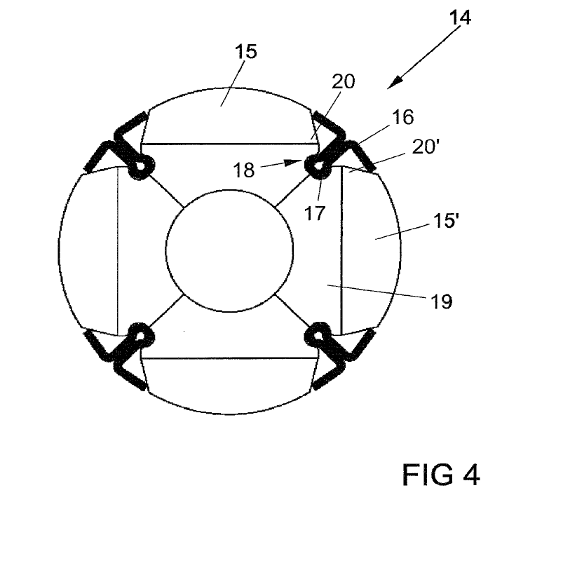

FIG. 4 shows a rotor 14 for the brushless direct current motor represented in FIG. 1, which differs from the rotor shown in FIG. 1 in that the number of permanent magnets 15, 15′ is identical to the number of spring elements 16. The spring elements 16 are held in a middle section 17 in cavities 18 of a support element 19 and grip edges 20, 20′ of the permanent magnets 15, 15′. The middle section 17 of the spring element 16 has the shape of a loop for ensuring an interlocking hold in the channel 18.

What is claimed is:

1. A brushless direct current motor comprising:
a stator having four coils;
a rotor within the stator, the rotor comprising:
a plurality of permanent magnets; and
a rotor support element configured to hold the plurality of permanent magnets;
wherein the permanent magnets are configured to face the stator and are preloaded against a periphery of the rotor support.

2. The brushless direct current motor as claimed in claim 1, further comprising:
a plurality of springs connected to the rotor support element, the springs being configured to preload the permanent magnet.

3. The brushless direct current motor as claimed in claim 2, wherein the permanent magnets have a recess, the recess being configured to receive a portion of each spring of the plurality of spring elements, said recess being located on an edge of each magnet of said plurality of magnets.

4. The brushless direct current motor as claimed in claim 2, wherein, the springs are configured to grip an edge of the rotor support element.

5. The brushless direct current motor as claimed in claim 4, wherein the rotor support element comprises a channel located such that it is parallel to a rotational axis of the rotor, the channel being configured to accommodate a section of a spring.

6. The brushless direct current motor as claimed in 5, wherein the spring has a substantially C-shaped cross section.

7. The brushless direct current motor as claimed in claim 6, wherein first and second springs are supported against each other and hold permanent magnets adjacent to one another.

8. The brushless direct current motor as claimed in claim 5, wherein the number of springs corresponds to the number of permanent magnets.

9. The brushless direct current motor as claimed in claim 8, wherein each spring element is held in a middle section of the rotor support element.

10. The brushless direct current motor as claimed in claim 9, wherein the permanent magnets and the rotor support element have planar contact surfaces that face each other.

11. The brushless direct current motor as claimed in claim 10, wherein the rotor support element is encapsulated in plas
